(19) United States
(12) Patent Application Publication
(10) Pub. No.: US 2012/0312890 A1
(43) Pub. Date: Dec. 13, 2012

(54) Fuel Nozzle with Swirling Vanes

(75) Inventor: Bryan Wesley Romig, Simpsonville, SC (US)

(73) Assignee: GENERAL ELECTRIC COMPANY, Schenectady, NY (US)

(21) Appl. No.: 13/157,345

(22) Filed: Jun. 10, 2011

(51) Int. Cl. B05B 1/26

(52) U.S. Cl. 239/5; 239/518

(57) ABSTRACT

A fuel nozzle includes a swirler and a fuel injector positioned upstream from the swirler. The swirler includes an inner hub, an intermediate dividing wall, an outer shroud, a number of inner swirling vanes, and a number of outer swirling vanes. The intermediate dividing wall is concentrically positioned about the inner hub. The outer shroud is concentrically positioned about the intermediate dividing wall. Each inner swirling vane extends between the inner hub and the intermediate dividing wall, and each outer swirling vane extends between the intermediate dividing wall and the outer shroud.

### TECHNICAL FIELD

The present disclosure generally relates to a fuel nozzle for a gas turbine, and more particularly relates to a fuel nozzle with swirling vanes.

### BACKGROUND OF THE INVENTION

A gas turbine generally includes a compressor, a combustion system, and a turbine section. Within the combustion system, air and fuel are combusted to generate a heated gas. The heated gas is then expanded in the turbine section to drive a load.

Historically, combustion systems employed diffusion combustors. In a diffusion combustor, fuel is diffused directly into the combustor where it mixes with air and is burned. Although efficient, diffusion combustors are operated at high peak temperatures, which creates relatively high levels of pollutants such as nitrous oxide (NOx).

To reduce the level of NOx resulting from the combustion process, dry low NOx combustion systems have been developed. These combustion systems pre-mix air and fuel to create a relatively lean air-fuel mixture that is combusted at relatively lower temperatures, generating relatively lower levels of NOx.

One problem with dry low NOx combustion is flame instability. Leaner air-fuel mixtures and lower temperatures tend to weaken and destabilize the flame. The flame may detach from its anchor point within the combustor, resulting in flameout. From the above, it is apparent that a need exists for a dry low NOx combustion system that exhibits improved flame stability, so that NOx emissions can be lowered without the corresponding risk of flameout.

### BRIEF DESCRIPTION OF THE INVENTION

A fuel nozzle includes a swirler and a fuel injector positioned upstream from the swirler. The swirler includes an inner hub, an intermediate dividing wall, an outer shroud, a number of inner swirling vanes, and a number of outer swirling vanes. The intermediate dividing wall is concentrically positioned about the inner hub. The outer shroud is concentrically positioned about the intermediate dividing wall. Each inner swirling vane extends between the inner hub and the intermediate dividing wall, and each outer swirling vane extends between the intermediate dividing wall and the outer shroud.

Other systems, devices, methods, features, and advantages of the disclosed fuel nozzle will be apparent or will become apparent to one with skill in the art upon examination of the following figures and detailed description. All such additional systems, devices, methods, features, and advantages are intended to be included within the description and are intended to be protected by the accompanying claims.

### BRIEF DESCRIPTION OF THE DRAWINGS

The present disclosure may be better understood with reference to the following figures. Matching reference numerals designate corresponding parts throughout the figures, and components in the figures are not necessarily to scale.

FIG. 1 is a cross-sectional plan view of a portion of a combustor of a gas turbine.

FIG. 2 is a perspective view of an embodiment of a swirler for a fuel nozzle.

FIG. 3 is a cross-sectional plan view of the swirler shown in FIG. 2.

FIG. 4 is a perspective view of an embodiment of a swirler for a fuel nozzle.

FIG. 5 is a cross-sectional plan view of the swirler shown in FIG. 4.

FIG. 6 is a perspective view of an embodiment of a swirler for a fuel nozzle.

FIG. 7 is a cross-sectional plan view of the swirler shown in FIG. 6.

### DETAILED DESCRIPTION OF THE INVENTION

Described below are embodiments of a fuel nozzle that improves flame stability within a combustor. The flame stability nozzle generally includes two sets of swirling vanes that are concentrically positioned with reference to each other. The vanes may cause an air-fuel mixture exiting the nozzle to develop a shear layer within the mixture, anchoring the flame within the combustor. The vanes also may increase the swirl of the air-fuel mixture, strengthening the recirculation zone along a centerline of the fuel nozzle where the flame tends to anchor. Increased flame instability may result, which permits optimizing the combustor for reduced NOx generation without the corresponding risk of flameout. For example, the combustor may be operated with leaner air-fuel mixtures or at lower temperatures.

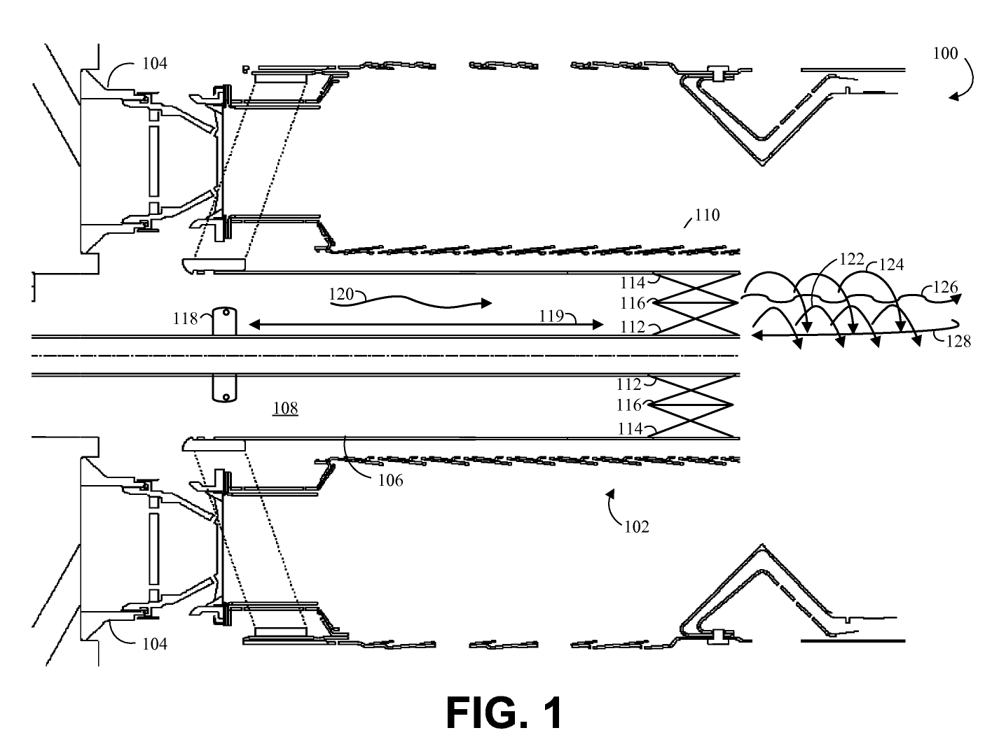

An embodiment of a combustor is shown in FIG. 1. The gas turbine also includes a compressor positioned upstream of the combustor and a turbine positioned downstream of the combustor. In operation, the compressor provides compressed air to the combustor 100, the combustor 100 combusts the compressed air with fuel to create a heated gas, and the heated gas is expanded in the turbine to drive a load. Energy is thereby extracted from the fuel to produce useful work.

Although only one combustor 100 is shown in FIG. 1, the gas turbine typically includes a number of combustors 100 arranged about the gas turbine in a circular array. Each combustor 100 is designed to create relatively low levels of nitrogen oxide (NOx) during the combustion process. The combustor 100 has at least one chamber, which serves as an envelope for controlled burning of the air and fuel mixture. The chamber is associated with one or more fuel nozzles that provide fuel or an air and fuel mixture to the chamber.

In some embodiments, the combustor 100 is a dual-mode combustor having a first chamber and a second chamber. The first chamber may receive air and fuel through a number of primary fuel nozzles, and the second chamber may receive air and fuel through a secondary fuel nozzle. The combustor can be operated in diffusion and pre-mixing modes, as described in U.S. Pat. No. 4,292,801. In other embodiments, the combustor 100 is a single-mode combustor having one chamber, which is typically operated in a pre-mixing mode. In such embodiments, the one chamber receives air and fuel through fuel nozzles positioned about the combustor.

The flame stability nozzle described herein can be employed in either a single-mode combustor or a dual-mode combustor, as either a primary fuel nozzle or a secondary fuel nozzle. In FIG. 1, the combustor is a dual-mode combustor, the flame stability nozzle 102 serves as the secondary fuel nozzle, and the primary fuel nozzles 104 are pre-mixing nozzles or “swozzles”. However, the present disclosure is not limited to this configuration. Instead, the present disclosure contemplates other single-mode or dual-mode combustors associated with at least one of the flame stability nozzles described herein.

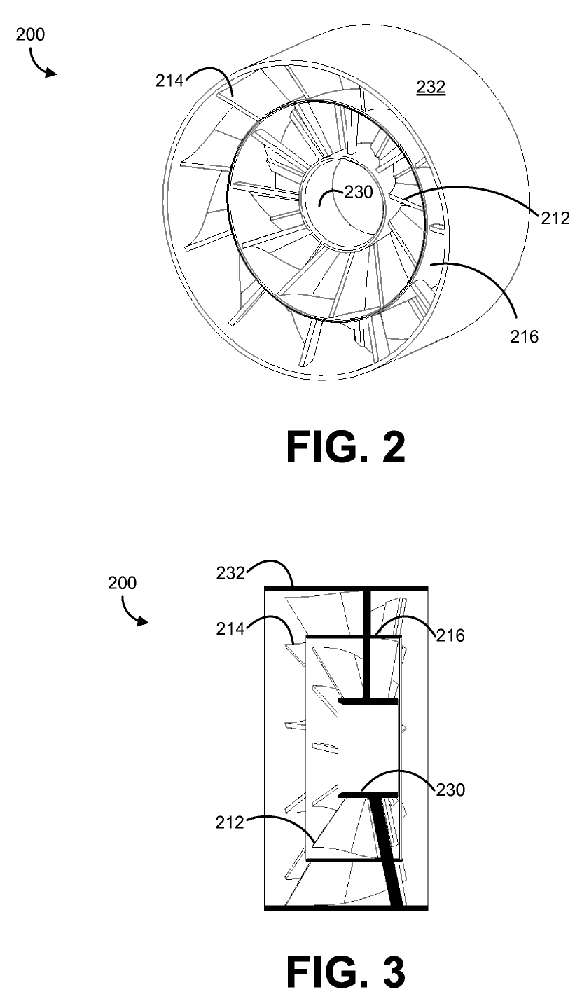

Turning to FIG. 1, the flame stability nozzle 102 generally includes a burner tube or body 106. The body 106 defines as internal passageway 108 for communicating air into the combustor 100 from the compressor. Within the internal passageway 108, a swirler 110 is provided that includes two sets of swirling vanes. The swirling vanes include an inner set of swirling vanes 112 separated from an outer set of swirling vanes 114 by a dividing wall 116. Examples of swirlers are described below with reference to FIGS. 2-7.

Upstream from the swirler 110, a fuel provider 118 is positioned in the internal passageway 108. The fuel provider 118 communicates fuel into the internal passageway 108 from a fuel source. For example, the fuel provider 118 may be a fuel peg as shown, although other suitable structures can be employed. The fuel provider 118 may be positioned upstream from the swirler 110 so that a mixing area 119 is defined therebetween. Providing the mixing area 119 upstream of the swirler 110 facilitates stabilizing the flame closer to the swirler 110 with reduced thermal stress on the nozzle body 106. Also, because the fuel is provided upstream of the vanes, the vanes may be solid, as the vanes need not have hollow interiors that define fuel plenums.

In operation, a flow of air is directed along the flame stability nozzle 102 through the interior passageway 108. As the flow of air passes the fuel provider 118, fuel is injected into the flow of air. As the air and fuel travel forward through the mixing area, the air and fuel mix to create an air/fuel flow 120. Upon reaching the swirler 110, the air/fuel flow 120 is separated by the dividing wall 116 into an inner air/fuel flow 122 and an outer air/fuel flow 124. The inner air/fuel flow 122 is turned by the inner set of swirling vanes 112, and the outer air/fuel flow 124 is turned by the outer swirling vanes 114. The inner and outer air/fuel flows 122, 124 then travel downstream of the swirler 110 forward toward the chamber.

Swirling the inner and outer air/fuel flows separately improves flame stability in the combustor. A low velocity region may be created between the flows, and the low velocity region may hold the flame. For example, at any given circumferential location about the swirler 110, the inner air/fuel flow 122 exiting the inner vanes 112 may have a different angular velocity or momentum than the outer air/fuel flow 124 exiting the outer vanes 114, resulting in the development of a shear layer 126 between the two flows. The shear layer 126 acts as a flame anchor point in the flow, increasing the stability of the flame. The inner air/fuel flow 122 also may exhibit increased swirl in comparison to than the outer air/fuel flow 124, such as in embodiments in which the inner swirling vanes 112 have a higher angle of incidence than the outer swirling vanes 124, creating a stronger recirculation zone 128 near the centerline of the fuel nozzle 102. The strengthened recirculation zone 128 facilitates flame stability on the centerline, where the flame tends to anchor.

Mixing the air and fuel upstream of the swirler 110 facilitates maintaining the flame relatively close to the swirler 110 with reduced thermal distress on the burner tube 106. The technical effect is that the stability of the flame is improved without a corresponding increase in undesirable flame holding. This result would not be achieved in a swozzle having fueled vanes, which requires a mixing area disposed downstream from the swirler.

To achieve these results, the inner and outer swirling vanes can have a variety of configurations. The inner vanes may rotate in the same direction as the outer vanes, or in a different direction. The inner vanes and the outer vanes may have the same angle of incidence with reference to the passing flow, or the inner and outer vanes may have different angles of incidence. The inner vanes also may align with the outer vanes, such as along their leading edges, or the inner vanes may be staggered with reference to the outer vanes. Examples configurations are described below.

FIGS. 2 and 3 illustrate an embodiment of a swirler 200 having inner and outer vanes 212, 214 that rotate in opposite directions. The swirler 200 includes an inner hub 230, an outer shroud 232, and an intermediate dividing wall 216. The hub 230, shroud 232, and wall 216 are concentrically positioned with reference to each other. The inner vanes 212 extend between the inner hub 230 and the intermediate dividing wall 216, and the outer vanes 214 extend between the intermediate dividing wall 216 and the outer shroud 232. The inner vanes 212 rotate in an opposite direction than the outer vanes 214. The inner vanes 212 have the same angle of incidence with reference to the passing flow as the outer vanes 214, although differing angles of incidence can be employed. The swirler 200 creates inner and outer flows that oppose each other, resulting in a shear layer between the flows that promotes flame holding.

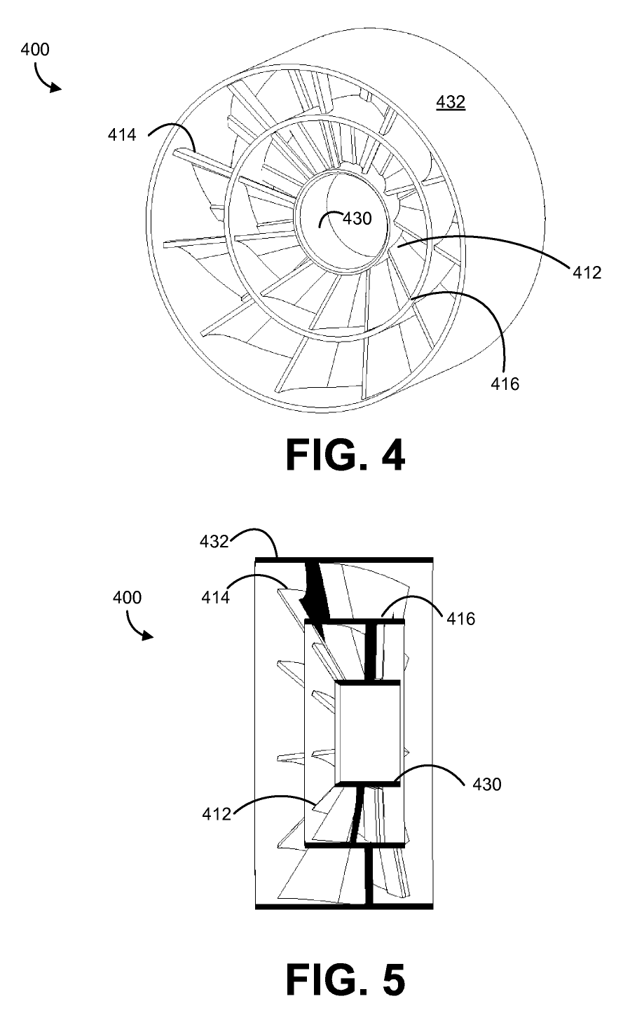

FIGS. 4 and 5 illustrate an embodiment of a swirler 400 having inner vanes 412 extending between the inner hub 430 and the intermediate dividing wall 416, and outer vanes 414 extending between the intermediate dividing wall 416 and the outer shroud 432, but the inner and outer vanes 412, 414 rotate in the same direction. The inner vanes 412 align with the outer vanes 414. More particularly, each inner vane 412 may have a leading edge that aligns with a leading edge of a corresponding outer vane 414. In the illustrated embodiment, the inner vanes 412 have different angles of incidence than the outer vanes 414, such as a higher angle higher angle of incidence or a lower angle of incidence, although in other embodiments the inner and outer vanes 412, 414 may have the same angle of incidence. The swirler 400 creates inner and outer flows that oppose each other, resulting in a shear layer between the flows that promotes flame holding. The interaction between the inner and outer flows can be controlled by varying the difference between the swirl angles, the interaction increasing with greater differences in swirl angle.

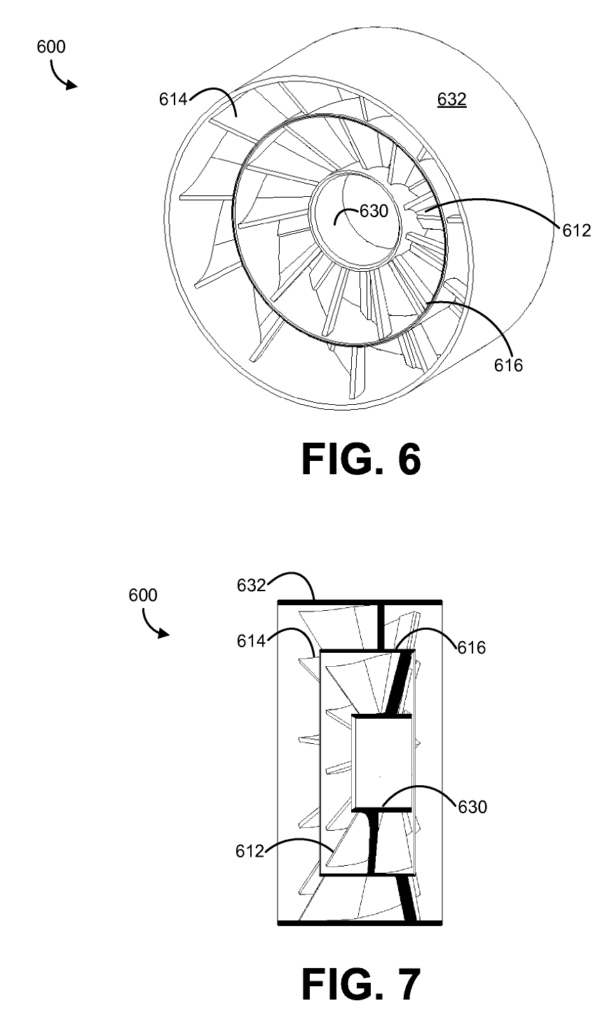

FIGS. 6 and 7 illustrate an embodiment of a swirler 600 having inner vanes 612 extending between the inner hub 630 and the intermediate dividing wall 616, and outer vanes 614 extending between the intermediate dividing wall 616 and the outer shroud 632, the inner and outer vanes 612, 614 rotating in the same direction. The inner vanes 612 are staggered with reference to the outer vanes 614. In the illustrated embodiment, the inner vanes 612 have a different angle of incidence than the outer vanes 614, such as a higher angle higher angle of incidence or a lower angle of incidence. However, the inner and outer vanes 612, 614 may have the same angle of incidence in some embodiments.

The swirler 600 creates inner and outer flows that oppose each other, resulting in a shear layer between the flows that promotes flame holding. The interaction between the inner and outer flows can be controlled by varying the difference between the swirl angles, the interaction increasing with greater differences in swirl angle. The interaction between the inner and outer vanes also can be controlled by varying the stagger of the vanes, which varies the stagger of the velocity profiles between the inner and outer flow, creating another area of flow interaction. Even if the inner and outer vanes have the same swirl angle, the flows have different momentums due to the offset velocity profiles, providing potential flame attachment points.

Any of the swirlers described with reference to FIGS. 2-7 can be substituted for an existing swirler in an existing fuel nozzle. In other words, the present disclosure contemplates a swirler for a fuel nozzle.

The fuel stability nozzle described herein facilitates flame stability, which enables operating the combustor in a manner that reduces NOx generation. For example, the combustor may employ a leaner air-fuel mixture or reduced temperatures with reduced occurrences of flameout.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

At least the following is claimed:

1. A fuel nozzle comprising:
a swirler comprising:
an inner hub,
an intermediate dividing wall concentrically positioned about the inner hub,
an outer shroud concentrically positioned about the intermediate dividing wall,
a plurality of inner swirling vanes, each inner swirling vane extending between the inner hub and the intermediate dividing wall,
a plurality of outer swirling vanes, each outer swirling vane extending between the intermediate dividing wall and the outer shroud, and
a fuel injector positioned upstream from the swirler.

2. The fuel nozzle of claim 1, wherein the inner swirling vanes rotate in the same direction as the outer swirling vanes.

3. The fuel nozzle of claim 1, wherein the inner swirling vanes rotate in the opposite direction of the outer swirling vanes.

4. The fuel nozzle of claim 1, wherein the inner swirling vanes align with the outer swirling vanes.

5. The fuel nozzle of claim 1, wherein the inner swirling vanes are staggered with reference to the outer swirling vanes.

6. The fuel nozzle of claim 1, wherein the inner swirling vanes have the same angle of incidence as the outer swirling vanes.

7. The fuel nozzle of claim 1, wherein the inner swirling vanes have a greater angle of incidence than the outer swirling vanes.

8. The fuel nozzle of claim 1, wherein the inner swirling vanes have a lesser angle of incidence than the outer swirling vanes.

9. The fuel nozzle of claim 1, wherein the fuel injector comprises a fuel peg positioned within a body of the fuel nozzle.

10. The fuel nozzle of claim 1, wherein the fuel nozzle is a secondary fuel nozzle for a two chamber combustor.

11. A combustor comprising:
a first combustion chamber;
at least one primary fuel nozzle in communication with the first combustion chamber;
a second combustion chamber;
a secondary fuel nozzle in communication with the second combustion chamber, the secondary fuel nozzle including:
a fuel injector adapted to inject fuel into a flow of air traveling through the secondary fuel nozzle,
an inner set of turning vanes, and
an outer set of turning vanes.

12. The combustor of claim 11, wherein the inner set of turning vanes is separated from the outer set of turning vanes by a dividing wall.

13. The combustor of claim 11, wherein:
the vanes of the inner set rotate in the opposite direction from the vanes of the outer set; and
the vanes of the inner set have the same angle of incidence as the vanes of the outer set.

14. The combustor of claim 11, wherein:
the vanes of the inner set rotate in the same direction as the vanes of the outer set;
the vanes of the inner set align with the vanes of the outer set; and
the vanes of the inner set have a different angle of incidence than the vanes of the outer set.

15. The combustor of claim 11, wherein:
the vanes of the inner set rotate in the same direction as the vanes of the outer set;
the vanes of the inner set are staggered with reference to the vanes of the outer set; and
the vanes of the inner set have a different angle of incidence than the vanes of the outer set.

16. A method comprising:
directing a flow of air through a fuel nozzle,
injecting fuel into the flow of air within the fuel nozzle to create a flow of air and fuel;
separating the flow of air and fuel into an inner flow of air and fuel and an outer flow of air and fuel;
turning the inner flow of air and fuel with a first set of swirling vanes; and
turning the outer flow of air and fuel with a second set of swirling vanes.

17. The method of claim 16, further comprising communicating the inner flow and the outer flow into a chamber of a combustor, a shear layer forming between the inner and outer flows to reduce flame instability in the combustor.

18. The method of claim 16, wherein the shear layer acts as a flame anchor point.

19. The method of claim 16, further comprising communicating the inner flow and the outer flow into a chamber of a combustor, a low velocity region forming between the inner and outer flows to reduce flame instability in the combustor.

20. The method of claim 16, further comprising communicating the inner flow and the outer flow into a chamber of a combustor, wherein at any given circumferential location about the fuel nozzle, the inner flow has a different angular velocity or momentum than the outer flow.
